(19) United States
(12) Patent Application Publication
(10) Pub. No.: US 2013/0124631 A1
(43) Pub. Date: May 16, 2013

(54) APPARATUS, SYSTEM, AND METHOD FOR DIGITAL COMMUNICATIONS DRIVEN BY BEHAVIOR PROFILES OF PARTICIPANTS

(71) Applicant: FIDELUS TECHNOLOGIES, LLC., New York, NY (US)

(72) Inventors: Ron ROSANSKY, New York, NY (US); Vlad HRABROV, Fair Lawn, NY (US)

(73) Assignee: FIDELUS TECHNOLOGIES, LLC., New York, NY (US)

(21) Appl. No.: 13/667,848

(22) Filed: Nov. 2, 2012

Related U.S. Application Data
(60) Provisional application No. 61/628,691, filed on Nov. 4, 2011.

(51) Int. Cl. H04L 29/06

(52) U.S. Cl. CPC H04L 65/403
USPC 709/204

(57) ABSTRACT

An apparatus and system are described for enhancing digital communications using behavior profiles of participants, including: a collaboration engine having a behavioral profile knowledge base, the collaboration engine being an internet cloud computing arrangement, in which the behavioral profile knowledge base includes behavioral profiles of at least two participants; a communication arrangement having a collaboration module for communicating with the collaboration engine; and at least two communication terminal arrangements for providing a communication session between the at least two participants. A related method is also described.

### CROSS-REFERENCE

This application claims the benefit of and priority to U.S. Provisional Patent Application Ser. No. 61/628,691 filed Nov. 4, 2011.

### FIELD OF THE INVENTION

The present invention relates to a communication apparatus, system, and method driven by behavior profiles of participants. The present invention further relates to an apparatus, system, and method for enhancing communication between participants based on behavior profiles and their interactions. The present invention further relates to a communication apparatus, system, and method providing recommendations for participants based on behavior profiles of other participants.

### BACKGROUND INFORMATION

Creating behavior profiles of users is believed to have been done in instances in which companies may target an individual user based on a determined behavior pattern of the user. It is believed that interactive voice recognition systems and online advertising publishers have used behavior pattern analysis to tailor an individual user's experience browsing the Internet or calling a voice recognition system based on a determined behavior pattern of the user, in which the user may receive an enhanced experience Internet browsing or using the interactive voice recognition system based on their behavior pattern or profile.

It is also believed, however, that communication systems have been somewhat rudimentary in their implementation and have not employed the benefits of behavior pattern analysis. Features of modern communication systems may allow for the display of the participants in a phone call using for example, caller ID, and may also provide other information, such as a phone number or address information about a caller to other participants. For example, in a call center this may also include account information and purchasing history. It is believed, however, that existing communication systems do not provide information about the personality and behavioral attributes of one of the communicators to another participant to enhance a conversation or interaction. In particular, it is believed that existing communication systems do not allow for integrating an individual's behavior profile within the communication system itself to enhance the conversation among the participants.

Thus, it is believed that there remains a need for a communication apparatus, system, and method that enhances communication between individual participants by providing a recommendation to a participant based on the behavior profile of another participant. It is further believed that there also remains a need for a process that provides behavior recommendations to communicants based on behavior profiles of the communicants and for a process that tailors behavior recommendations to communicants based on an ongoing communication regardless of type (i.e. phone call, email, instant message, etc).

### SUMMARY OF THE INVENTION

A communication apparatus, system, and method are described that enhance communication between participants by providing actionable recommendations to the participants based on the behavior type of the other participants, in which a knowledge base stores behavior profiles of participants and collaboration engines retrieve the profile based on the identification of a participant by some unique key, and in which the communication system may monitor the communication and provide subsequent recommendation actions to the participant(s) based on the behavior profiles of the participants.

In particular, the exemplary embodiments and/or exemplary methods of the present invention are directed to a method for enhancing digital communications using behavior profiles of participants, the method including: upon initiation of a communication by one of the participants, using a processor system to retrieve the behavior profiles of the participants from a knowledge base generating executable actions for each of the participants from a determined behavior type from the stored behavior profiles of the other participants or a most common behavior type if the stored behavior profiles of the other participants do not exist; and transmitting the executable actions to communication devices of the participants, each participant receiving a distinct set of executable actions.

The exemplary embodiments and/or exemplary methods of the present invention further provide for the foregoing method for providing additional executable actions from the knowledge base to each of the participants based on a monitoring of the communication.

The exemplary embodiments and/or exemplary methods of the present invention further provide for the foregoing method in which the behavior profiles of the participants are retrieved using a unique key for each of the participants.

The exemplary embodiments and/or exemplary methods of the present invention further provide for the foregoing method in which the behavior profiles of the participants may be dynamically created for the participants whose profiles do not exist in the knowledge base or a default general behavior type is used for such participants.

The exemplary embodiments and/or exemplary methods of the present invention further provide for the foregoing method in which the communication is at least one of a telephone call, an E-mail, a videoconference call, an instant message, and a message through a social media platform.

The exemplary embodiments and/or exemplary methods of the present invention further provide for the foregoing method in which the behavior profiles are retrieved from the knowledge base through a collaborator client using a representational state transfer message.

The exemplary embodiments and/or exemplary methods of the present invention further provide for the foregoing method in which the executable actions are transmitted to the communication devices through at least one collaborator client using a representational state transfer message.

The exemplary embodiments and/or exemplary methods of the present invention further provide for the foregoing method in which the monitoring of the communication includes measuring a response time by each of the participants, as well as the amount of time taken by each of the participant during the communication, establishing a speak-to-listen rate for each participant during on-going communication.

The exemplary embodiments and/or exemplary methods of the present invention further provide for the foregoing method in which the monitoring of the communication includes analyzing written text of the communication for length, key phrases, and style.

The exemplary embodiments and/or exemplary methods of the present invention further provide for the foregoing method in which the monitoring of the communication includes measuring at least one of: volume level, tonality, pitch level, and general psychological measurements of each of the participants.

The exemplary embodiments and/or exemplary methods of the present invention further provide for the foregoing method in which the unique key includes an E-mail address(es).

The exemplary embodiments and/or exemplary methods of the present invention further provide for the foregoing method in which if the unique key is not found, default executable actions are generated based on a default behavior profile.

The exemplary embodiments and/or exemplary methods of the present invention further provide for the foregoing method in which an identifier, such as a phone number, of one of the participants is used to retrieve the unique key.

The exemplary embodiments and/or exemplary methods of the present invention further provide for the foregoing method in which a phone number of one of the participants is used to retrieve the E-mail address.

The exemplary embodiments and/or exemplary methods of the present invention further provide for the foregoing method where written text of the communication is analyzed for length, key phrases, and style.

The exemplary embodiments and/or exemplary methods of the present invention further provide for a method for generating executable actions for enhancing digital communications using behavior profiles of participants, the method including: using a processor system to retrieve a unique key of one of the participants from a knowledge base, in which an identifier is used to retrieve the unique key if the unique key is not readily determined; identifying a participant from the unique key; retrieving specific executable actions from the knowledge base based on a behavior type of the identified participant and/or based on combination of behavior types of communication participants: wherein if the unique keys is(are) not found, default executable actions are built from the knowledge base based on a default behavior profile(s); and transmitting the specific executable actions or the default executable actions from the knowledge base to relevant participants in the communication.

The exemplary embodiments and/or exemplary methods of the present invention further provide for the foregoing method in which the unique key is an E-mail address.

The exemplary embodiments and/or exemplary methods of the present invention further provide for the foregoing method in which the identifier is at least one of: a phone number, a screen name, a username, and a log in name.

The exemplary embodiments and/or exemplary methods of the present invention further provide for the foregoing method in which if the participant cannot be identified from the retrieved unique key, the default executable actions are built based on the default behavior profiles.

The exemplary embodiments and/or exemplary methods of the present invention further provide for the foregoing method in which the default executable actions are transmitted to the other participants in the communication in the form of prompts and queues.

The exemplary embodiments and/or exemplary methods of the present invention further provide a system for enhancing digital communications using behavior profiles of participants, including: a processor system having a knowledge base, in which, upon initiation of a communication by one of the participants, the processor system is operable to retrieve the behavior profiles of the participants from the knowledge base; a generating arrangement to generate executable actions for each of the participants from a determined behavior type from the stored behavior profiles of the other participants; and a transmitting arrangement to transmit the executable actions to communication devices of the participants, each participant receiving a distinct set of executable actions.

The exemplary embodiments and/or exemplary methods of the present invention further provide for the foregoing system in which the processor system provides additional executable actions from the knowledge base to each of the participants based on a monitoring of the communication.

The exemplary embodiments and/or exemplary methods of the present invention further provide a computer readable medium having a program, which is executable by a processor, including: a program code arrangement having program code for enhancing digital communications using behavior profiles of participants, by performing the following: upon initiation of a communication by one of the participants, using a processor system to retrieve the behavior profiles of the participants from a knowledge base; generating executable actions for each of the participants from a determined behavior type from the stored behavior profiles of the other participants; and transmitting the executable actions to communication devices of the participants, each participant receiving a distinct set of executable actions.

The exemplary embodiments and/or exemplary methods of the present invention further provide for the foregoing computer readable medium in which additional executable actions are provided from the knowledge base to each of the participants based on a monitoring of the communication and conditions for activation of specific relevant types of executable actions.

The exemplary embodiments and/or exemplary methods of the present invention further provide a system for enhancing digital communications using behavior profiles of participants, including: a collaboration engine having a behavioral profile knowledge base, the collaboration engine being an internet cloud computing arrangement, in which the behavioral profile knowledge base includes behavioral profiles of participants if the behavior profiles exist, a communication arrangement having a collaboration module for communicating with the collaboration engine; and at least two communication terminal arrangements for providing a communication session between the participants.

The exemplary embodiments and/or exemplary methods of the present invention further provide the foregoing system, in which, upon initiation of a communication by one of the participants, the collaboration engine and the collaboration module of the communication arrangement are operable to retrieve the behavior profiles of the participants from the knowledge base, in which the collaboration engine and the collaboration module of the communication arrangement are operable to generate executable actions for each of the participants from a determined behavior type from the stored behavior profiles of the other participants, in which the collaboration engine and the collaboration module of the communication arrangement are operable to transmit the executable actions to communication devices of the participants, each participant receiving a distinct set of executable actions, and in which the collaboration engine and the collaboration module of the communication arrangement are operable to provide additional executable actions from the knowledge base to each of the participants based on a monitoring of the communication.

### BRIEF DESCRIPTION OF THE DRAWINGS

FIG. 1 is a diagram of a communication system running dynamic executable actions for communication according to the present invention.

FIG. 2 is a diagram of various processes for generating behavior profiles according to the present invention.

FIG. 3 is a flow diagram of a process for building dynamic executable actions of the communication system according to the present invention.

FIG. 4 is a diagram of the communication system running dynamic executable actions during operation, according to the present invention.

### DETAILED DESCRIPTION

The exemplary embodiments and/or exemplary methods of the present invention are described in detail as to specific exemplary embodiments and/or exemplary methods of the present invention. It is to be understood, however, that these embodiments and/or methods are intended only as illustrative examples and that the present invention is not so limited.

Exemplary embodiments and/or exemplary methods of the present invention provide a communication apparatus, system, and method to enable enhanced communication between individual participants by providing behavior recommendations to each participant based on the behavior profile of the other participants while the system also takes theirs into account. The communication system includes a collaboration engine having a knowledge base and a communications manager that facilitates communication between participants in a conversation. The communications manager includes collaborator clients or a collaboration engine plug-in that allows for the receipt of executable instructions pertaining to the behavior profiles of the participants of the communication and transmits queues to the individual participants based on the monitoring of the conversation. The queues may be displayed to the participants on a telephone, computer, smart phone, or other comparable device with a displayable interface.

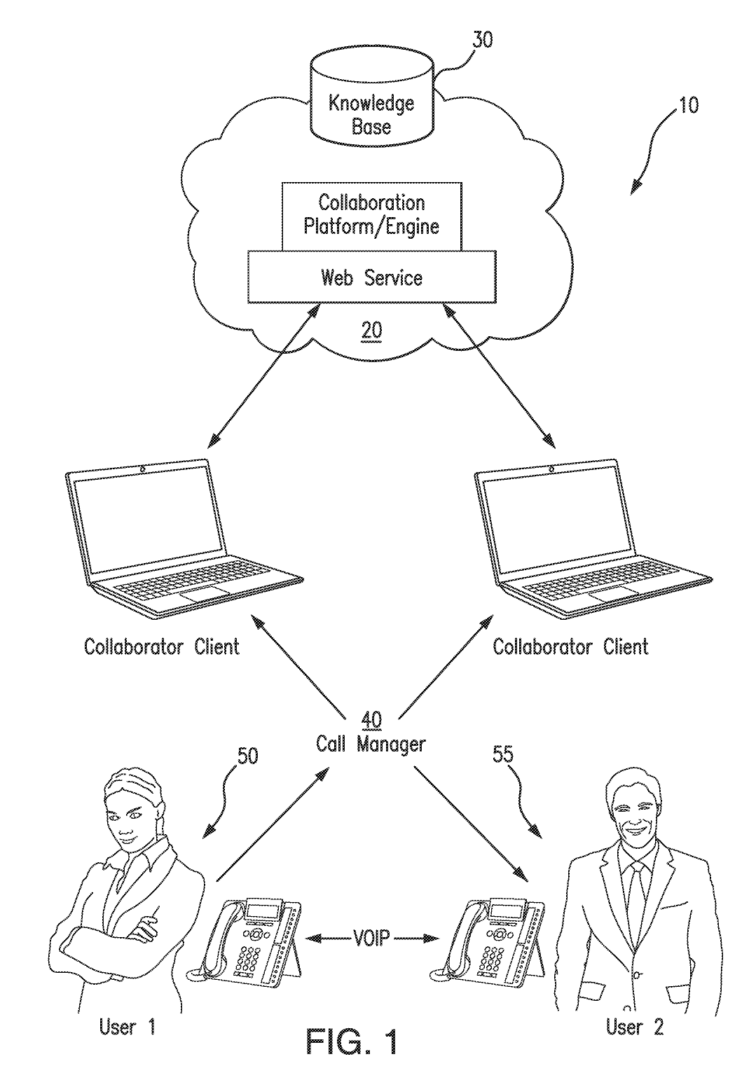

FIG. 1 shows a diagram of a communication system 10 running dynamic executable actions of the exemplary embodiments and/or exemplary methods of the present invention. Communication system 10 may include collaboration engine 20 and communications manager 40.

Collaboration engine 20 may house or otherwise have access to knowledge (behavioral profile) base 30. Knowledge base 30 may be an arrangement that may collect and store any acquired knowledge by the system that is later used for retrieval. In an example embodiment, knowledge base 30 may contain information allowing the building of the executable actions for particular behavior profiles and/or combinations of profiles for entities participating in a specific collaboration. This information related to each participant may include an E-mail address, a phone number, an associated profile type, or other relevant information. Knowledge base 30 may also include definitions of communication type-driven executable actions. Collaboration engine 20 may determine the executable actions after determining that the proposed actions are actionable. Collaboration engine 20 may be situated locally or remotely.

Communication manager 40 may interact with collaboration engine 20 through at least one collaborator client. In an embodiment, each collaborator client may be embodied as an application integrated on a user terminal, which may be embodied, for example, as a telephone, desktop, laptop, hand-held device, personal digital assistant (PDA), television set-top Internet appliance, mobile telephone, smart phone, iPod™, iPhone™, iPad™, etc., or as a combination of one or more thereof, or other comparable device. The collaborator client may interact with the collaboration engine 20 through Web Services, such as, for example, through a representational state transfer (“REST”) interface.

During a communication, such as, for example, a telephone conversation, communications manager 40 may be connected to participants through communication devices 50 and 55, as shown in FIG. 1. It should be understood that communications manager 40 is not restricted to connecting to only two devices, since communications manager 40 may be connected to a plurality of communication devices. In an exemplary embodiment, the number of communication devices connected to communications manager 40 at one time may be equal or otherwise correspond to the number of participants in a communication arrangement. In an alternative embodiment, communications manager 40 may be connected to a plurality of communication devices through a computer or communications network.

In an embodiment, the collaborator clients may be configured on communication devices 50, 55. In an alternate embodiment, communication devices 50, 55 may be separate devices from the devices hosting the collaborator clients. Communication devices 50, 55 may be a user terminal, which may be embodied, for example, as a telephone, desktop, laptop, hand-held device, personal digital assistant (PDA), television set-top Internet appliance, mobile telephone, smart phone, iPod™, iPhone™, iPad™, etc., or as a combination of one or more thereof, or other comparable device.

Communications system 10 may include knowledge base(s) 30, which may be a knowledge base that holds a listing of all behavior profiles that have been created and submitted by external users. In an exemplary embodiment, collaboration engine 20 may be connected externally to the processor. Exemplary embodiments of the present invention are directed to collaboration engine 20 and its processor(s), which may be implemented using processing circuits or devices or combinations thereof, such as, for example, a central processing unit (CPU) of a personal computer (PC) or other workstation processor. Collaboration engine 20, communications manager 40, and knowledge base 30 may be CPUs or components within a network of computing resources that may execute code provided, for example, on a hardware computer-readable medium including a memory device, to perform one or more of the methods described herein.

Exemplary embodiments of the present invention provide a collaboration engine 20 executing instructions stored on the engine to perform one or more of the methods described herein alone or in combination.

In an exemplary embodiment and/or method, a participant using communication device 50 may initiate communication with a participant using communication device 55. An initiation of communication may include, but is not restricted to, for example, a telephone call, a videoconference call, an E-mail, an instant message (IM) through a variety of platforms including AIM™, GChat™, and Facebook™ Chat, an initiation through an Internet website, and communication through the use of social media, including Twitter™, Facebook™, Myspace™, Google+™, and/or other social media platforms. Communications manager 40 may assist in routing the communication from communication device 50 to communication device 55.

In an exemplary embodiment, communications manager 40 may serve as a telecommunications hub that may route calls from communication device 50 to communication device 55. In an alternate embodiment, communications manager 40 may act as a server to transmit communication such as E-mail or browser based messages from communication device 50 to communication device 55. In an alternate embodiment, communications manager 40 may operate to monitor communications between communication device 50 and communication device 55, and deliver prompts to both devices as determined by the system.

During the monitoring of the communication between devices 50 and 55, measurements may be taken of the communication and compared to specific conditions. These measurements may include, but are not restricted to, response time, talk time, speaker volume, tonality, pitch level, and general psychological measurements.

Knowledge base 30, may store a plurality of generated behavior profiles for the communication system 10. When communication is initiated by communication device 50 to communication device 55, communications manager 40 may request behavior profile(s) or behavior profile type(s) from the knowledge base 30 corresponding to the participants who are using devices 50 and 55. Communications manager 40 may request the behavior profile information from the knowledge base 30 by interfacing with the collaboration engine through the respective collaborator clients. These collaborator clients may be implemented on communication devices 50, 55, or implemented on external hardware. Communications manager 40 may request the profiles from the knowledge base 30 by sending a REST message from a collaborator client to the collaborator engine 20.

The behavior profiles corresponding to the participants using devices 50 and 55 may be retrieved from knowledge base 30. Collaboration engine 20 may prepare executable instructions corresponding to each of the retrieved profile or use executable actions available in the knowledge base 30 for specific behavior profiles and specific communications types. The executable instructions may include objects that contain data and methods allowing delivery of the collaboration enhancement prompts. Collaboration engine 20 may transmit the executable instructions to communications manager 40 via a REST message through the collaborator clients.

Communications manager 40 may transmit a recommendation based on the executable actions to communication device 50, and the recommendation may be correlated to a behavior profile type of the participant on communication device 55. Communications manager may also transmit a recommendation based on the executable instructions to communication device 55 and the interaction between the communication devices. The transmitted recommendation may be correlated to a behavior profile type of the participant on communication device 50. The recommendation queues transmitted to communication devices 50 and 55 may provide information or recommendations for the participant to assist in interaction with the other participants. Recommendations transmitted to each participant may be based on the behavior profile of the other participants, while taking in consideration the behavior profile of the participant for whom the recommendations are built.

For example, the system may provide a recommendation for a first participant on communication device 50 on how to interact with a second participant on device 55, based on the behavior profile of the second participant. The recommendation transmitted in the instruction queue to the first participant may also take into consideration the first participant's own behavior profile, and the system may determine that the recommendation is a suitable action for an individual having the first participant's behavior profile to take during an interaction with an individual having the second participant's behavior profile.

Conversely, the system may provide a recommendation for the second participant on communication device 55 on how to interact with the first participant, based on the behavior profile of the first participant. The recommendation transmitted in the instruction queue to the second participant may also take into consideration the second participant's own behavior profile, and the system may determine that the recommendation is a suitable action for an individual having the second participant's behavior profile to take during an interaction with an individual having the first participant's behavior profile.

The instructions transmitted by communications manager 40 to the communication devices may provide the participants with information that enhances communication among the participants. Examples of recommendations may include (but are not restricted to) the following: suggesting a speaking tone or verbosity for a participant; and action directives for a participant, such as, for example, providing more detail or providing a brief overview.

Communications manager 40 may be connected to collaborator clients integrated on user terminals to allow the communications manager 40 to monitor the entire conversation between communication devices 50 and 55. An entire conversation may, for example, refer to a chain of e-mails, an entire telephone conversation, and/or a series of social media messages, etc. Communications manager 40 may actively monitor the conversation and provide additional instruction queues to the communication devices 50 and 55 based on the conversation and the participants' behavior profiles. These additional instruction queues may be transmitted from communications manager 40 to communication devices 50, 55.

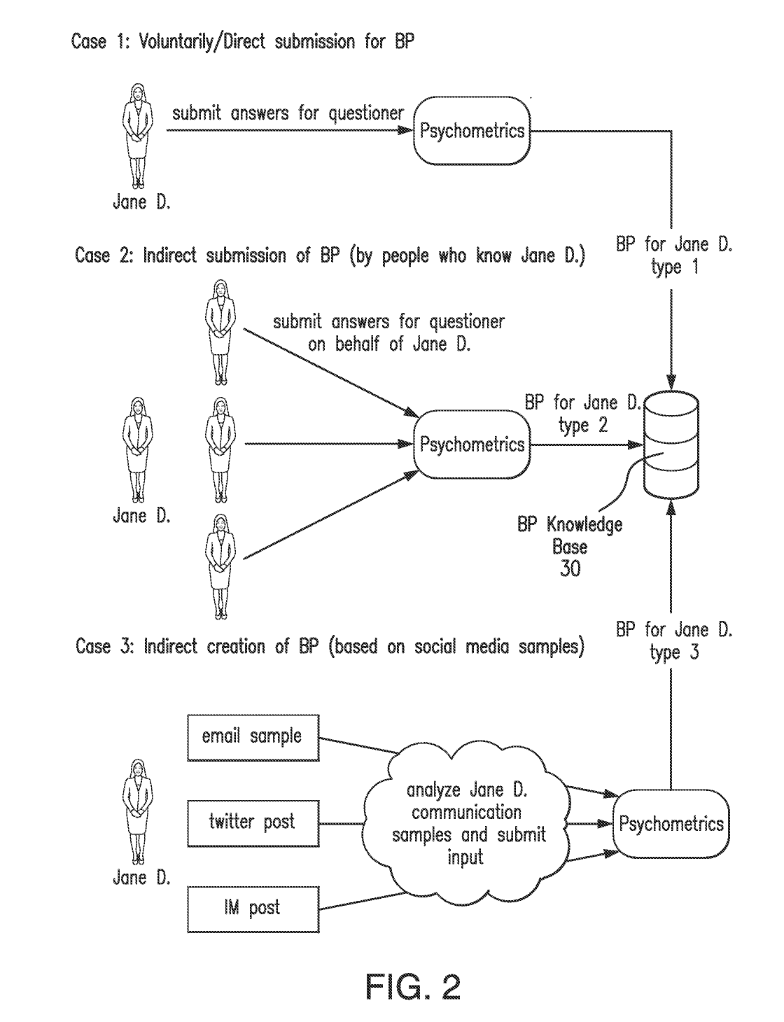

FIG. 2 illustrates various processes for populating behavior profiles that are stored in knowledge base 30. In an exemplary embodiment, an individual user, “Jane D.” may directly submit answers to a questionnaire for behavior pattern analysis. This may constitute a voluntary submission in which an individual directly answers questions about himself. The information submitted by the individual may be processed by available psychometric software to generate a behavior profile for the individual. Behavior profiles may also be generated from the submitted information using available models for analyzing behavior patterns and generating behavior profiles. These models may include, for example, Dominance, Influence, Steadiness, and Compliance (DiSC®), Myers-Briggs Type Indicator (MBTI), and Hermann Brain Dominance Instrument (HBDI). In an exemplary embodiment, behavior profiles may be generated using a combination of these various models, or other suitable models or systems. The results of the software or model analysis may be adapted to identify a behavior profile type, and a generated behavior profile for the individual may then be stored in knowledge base 30.

In an exemplary embodiment, external users may submit answers to a questionnaire about a principal, for behavior pattern analysis, which is further shown in FIG. 2. This may constitute an indirect submission in which external users, who know the principal, may answer questions about the principal. The information gathered from the questionnaires answered by the external users may be processed by psychometric software or one of the available models and merged to generate a single behavior profile for the individual. A generated behavior profile for the principal may be stored in knowledge base 30, and a behavior profile type for the principal may be then be identified.

In an exemplary embodiment, communication samples originating from an individual user may be used for behavior pattern analysis, which is further illustrated in FIG. 2. This may include receiving communication samples from the individual, such as e-mails, Facebook™ and Twitter™ messages, instant messages, or lectures created by the individual. These samples may be processed by the psychometric software or one of the available models or systems to generate a behavior profile for the individual. A generated behavior profile for the individual may be stored in knowledge base 30 and a behavior profile type of the individual may then be identified.

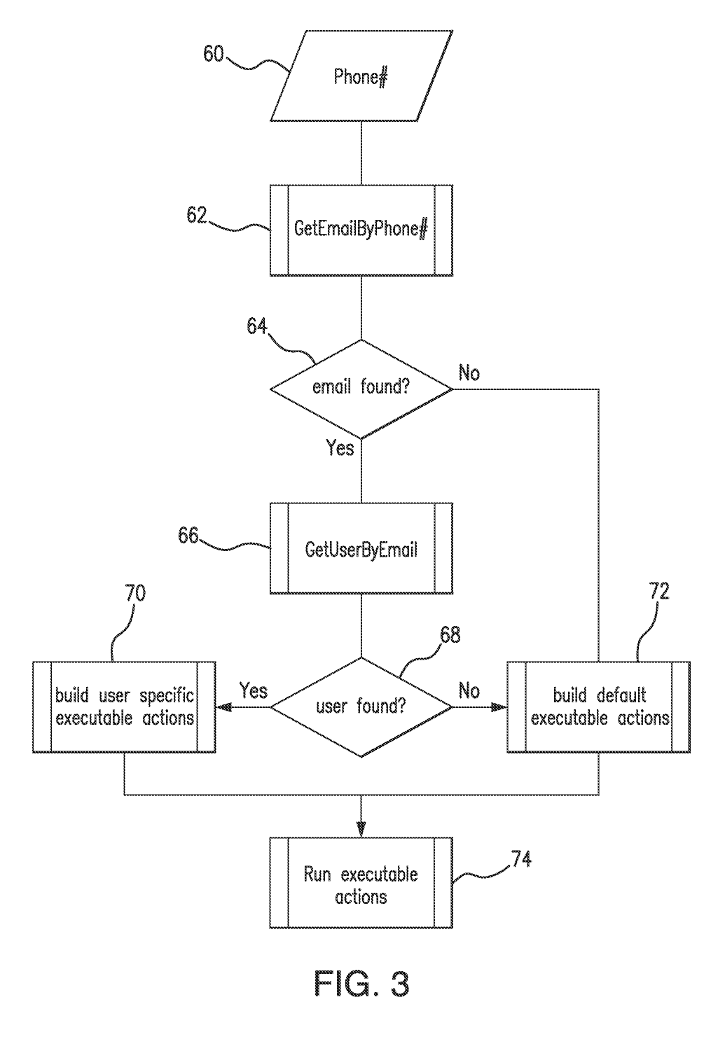

FIG. 3 shows a flow diagram of the process (which may be implemented in a computer system or network) for building dynamic executable actions of the communication system by retrieving behavior profiles for each participant in a communication. Knowledge base 30 may be prepopulated with executable actions for each of the generated behavior profiles. The configured executed actions may be based on interchange between the communications manager 40 and the collaboration engine 20 through the collaborator clients. Collaboration engine 20 may be driven by objects from knowledge base 30 that describe a variety of executable actions for each profile type. In an example embodiment, a subset of the executable actions may be used for a particular type of communication engagement. A subset of executable actions may have a general type applicability and may apply to all forms of communications.

Alternatively, a subset may carry specific type instructions that are only used for a specific communications medium. For example, in an example embodiment, different subsets may be used for E-mail and phone communications. General type executable actions provided for both E-mail and phone may include <do> or <donot>. In this regard, however, specific type executable actions for a phone medium may include <do4phone, monitor=voice-volume> or <voice, condition=raised>. These specific type executable actions may not be compatible with E-mail correspondence. Conversely, specific type executable actions for E-mail may include <do4email> or <detailemail>, actions that may not be compatible with a phone conversation.

In the system, a unique key may be used to retrieve executable actions based on a participant's behavior profile from the knowledge base 30. An E-mail address may be particularly suitable as a unique key, since an E-mail address cannot be reassigned to another user. A participant's E-mail address may be taken from an E-mail correspondence, or if a communication medium (such as, for example, a social media platform) is used to communicate between participants, the E-mail address associated with the social media account may be used as the unique key to retrieve the participant's behavior profile.

In an exemplary embodiment, such as, for example, during a phone call or a videoconference where only the participant's telephone numbers are used, a participant's phone number may be used to retrieve the participant's E-mail address, since a phone number may be associated with an E-mail address. In step 60, where a phone number is used to retrieve the executable actions, communications manager 40 determines a phone number from one of communication devices 50 or 55. In step 62, the collaborator clients may transmit the phone number to collaboration engine 20 to retrieve an E-mail address associated with the phone number. In step 64, collaboration engine 20 may check knowledge base 30 to determine if there is an E-mail for a participant with that particular phone number.

If collaboration engine 20 does not find an E-mail address associated with the phone number, the system may move to step 72. In step 72, collaboration engine 20 may build default executable actions using a default behavior pattern from a most common behavior profile. The system may transmit these default actions back to the communications manager 40 through the collaborator clients, which may then run the actions and transmit them, in step 74, to the communication devices. Also, in step 74, the communications manager 40 may run the default executable actions by monitoring the communication and sending recommendations to the participants as determined by the default executable actions.

If the collaboration engine 20 finds an E-mail address associated with a phone number in step 64, the system may move to step 66, in which collaboration engine 20 may retrieve the associated E-mail address. In step 68, collaboration engine 20 may check knowledge base 30 to determine whether a participant is associated with the E-mail address, so as to determine a behavior profile type of the participant. In some instances, for example, an E-mail address may be stored in knowledge base 30, but there may be no stored behavior profile information pertaining to the participant. If the participant is not found by collaboration engine 20, the system may move to step 72, in which the collaboration engine 20 may build default executable actions using a default behavior pattern or retrieve default executable actions from the knowledge base 30. These default actions may be transmitted back to communications manager 40 through the collaborator clients, and the communications manager 40 may run the actions and transmit them to the communication devices in step 74, in which the communications manager 40 may run the default executable actions by monitoring the communication and sending recommendations to the participants as determined by the default executable actions.

In step 68, if the participant is found by collaboration engine 20, the system may move to step 70, in which the collaboration engine 20 may build user specific executable actions based on the behavior profile type of the participant. Communications manager 40 may identify the profile type for each user by making web service calls to collaboration engine 20, in which collaboration engine monitors each user. The system may then transmit these user specific executable actions back to the communications manager 40 through the collaborator clients, which may run the actions and transmit them to the communication devices in step 74, in which the communications manager 40 may run the user-built executable actions by monitoring the communication and sending recommendations to the participants as determined by the user built executable actions.

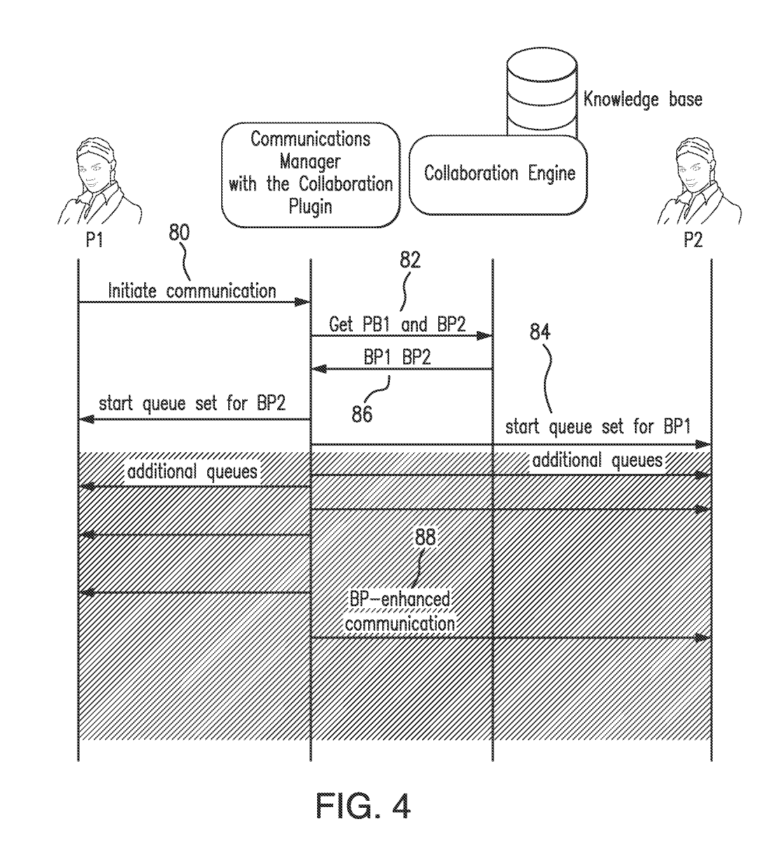

FIG. 4 shows a diagram of communication system 10 during its operation. In step 80, a first participant initiates a communication with a second participant. This communication may be routed through communications manager 40. In step 82, the collaborator clients or a collaboration plug-in may request the behavior profiles and related executable actions for the first and second participants from the knowledge base 30. This request may be made using an E-mail address or phone identifier as depicted in FIG. 3. In step 84, executable actions related to a behavior type of the first participant may be sent from collaboration engine 20 to communications manager 40 through the collaborator clients, along with executable actions related to a behavior type of the second participant. In step 86, communications manager 40 may transmit an initial set of executable actions based on the second participant, to the first participant. Communications manager 40 may also transmit an initial set of executable actions based on the first participant, to the second participant. In step 88, the communications manager 40 may monitor the entirety of the communications among all of the participants by measuring response time, tonality, pitch level, or general psychological measurements, and the system may deliver additional executable actions to the participants to assist in the enhancement of the conversation.

Some executable actions may be only involved by a triggering events such as a screen prompt. In an example embodiment, a participant may be given the prompt: “Calm down and propose to table this topic for now”. This screen prompt may, for example, be a result of the trigging event “high pitch of voice” or “high volume of voice”. These executable actions may assist to bring a conversation in the above example, back to a normal, controllable exchange.

The following is an exemplary use of the communication system 10 during a telephone conference between two participants. Participant 1 may be classified by collaboration engine 30 as having the behavior type of a highly dominant person. Participant 2 may be classified by collaboration engine 30 as having the behavior type of a steady person. The instruction prompts displayed to the individual participants may be displayed in the text boxes below. Each of the participants may receive an initial executable action as soon as communication is initiated and before dialog begins.

Initial executable action displayed to Participant 1: Slow down your pace, give [Participant 2] a chance to think and provide adequate detail.

Initial executable action displayed to Participant 2: Speed up your pace, let [Participant 1] get to the point.

Participant 1: “Hi, how are you this morning?”

Participant 2: “Fine, [Participant 1]. What's up?”

Participant 1: “Good. Where are you on the Barnes project?”

Participant 2: “Uh, the Barnes project . . . ” (floundering, trying to remember what Participant 1 wanted on this one of 20 projects that he is working on).

Additional recommended action displayed to Participant 2: Avoid overwhelm, ask [Participant 1] a question to clarify or hang in there and get clarification.

Participant 2: “[Participant 1], sounds urgent—what are you looking for specifically?”

Additional recommended action displayed to Participant 1: More detail, give [Participant 2] time.

(Participant 1 realizes his mistake, he thought Participant 2 could read his mind and didn't give him enough data to be effective). Participant 1: “Sorry, yes, it is urgent. I have a call with the client at Barnes in 10 minutes. I'm sorry that I couldn't give you more lead time, I just found out about it myself. Do we have an update on when the implementation will be complete?”

(This gave Participant 2 time to find his notes). Participant 2: “We are currently on schedule to finish the project on time which is what we promised.”

(Participant 2 remembers a problem and doesn't want to bring it up but knows that he should).

Additional recommended action displayed to Participant 1: Keep your voice non-threatening and probe for problems or back off but probe for problems.

Participant 1: “[Participant 2], did I hear something about a possible hold-up on this project? If there is anything, just briefly, I'd like to know so that I can be proactive with the customer.”

(Participant 2 gets ample time for his lead in). Participant 2: “Yes, briefly, so at most the impact will be a one week delay.”

Participant 1: “Why didn't I hear about this sooner from you?”

(Participant 1 is getting agitated).

Additional recommended action displayed to Participant 2: Don't get overwhelmed, give the data briefly or hang in there, stay calm, and be brief.

Participant 2: “I'm sorry, [Participant 1], I heard about it yesterday just before the Atlanta project blew up. I'll put an extra guy on it and keep you posted. Is there anything else that I can give you for your call?”

Additional recommended action displayed to Participant 1: Provide reassurance and thank him.

Participant 1: “Thanks, [Participant 2]. As you know, this is a sensitive situation. Please contact me immediately either with resolution or if there are other issues. Thanks for the quick update. I have what I need for the call.”

Additional recommended action displayed to Participant 2: Acknowledge urgency and end the call quickly.

Participant 2: “No problem, [Participant 1], I know this matters a lot. I'll keep you informed.”

As demonstrated by the example communication, communication system 10 may enhance the conversation between individuals having distinct behavior types. Both participants may receive initial recommended actions at the beginning of the conversation. In the example implementation, communication system 10 may provide an initial recommendation for Participant 1 to provide detail in the conversation and speak in a slow manner, based on a determination of the behavior profile type of Participant 2. Communication system 10 may provide, for example, based on a determination of the behavior profile type of Participant 1, an initial recommendation for Participant 2 to speak faster.

Communication system 10 which may monitor the conversation through the collaboration manager 40 and the collaborator clients, may provide additional recommended actions to the participants as needed. In the exemplary implementation, when a determination is made that Participant 2 is floundering, communication system 10 may recommend to Participant 2 to avoid being overwhelmed and seek clarification from Participant 1. Communication system 10 may also communicate to Participant 1 that Participant 2 needs more detail to respond to Participant 1's inquiry. Communication system 10 may also provide additional recommendations to Participant 1 to remain non-threatening as the communications manager 40 determines that Participant 1 may be agitated.

The exemplary embodiments and/or exemplary methods of the present invention are specifically illustrated and/or described herein. It will, however, be appreciated that modifications and variations of the present invention are covered by the descriptions here without departing from the spirit and scope of the present invention.

What is claimed is:

1. A method for enhancing digital communications using behavior profiles of participants, the method comprising:
upon initiation of a communication by one of the participants, using a processor system to retrieve the behavior profiles of the participants from a knowledge base;
generating executable actions for each of the participants from a determined behavior type from the stored behavior profiles of the other participants or a most common behavior type if the stored behavior profiles of the other participants do not exist; and
transmitting the executable actions to communication devices of the participants, each participant receiving a distinct set of executable actions.

2. The method of claim 1, further comprising:
providing additional executable actions from the knowledge base to each of the participants based on a monitoring of the communication.

3. The method of claim 1, wherein the behavior profiles of the participants are retrieved using a unique key for each of the participants.

4. The method of claim 1, wherein the communication is at least one of a telephone call, an E-mail, a videoconference call, an instant message, and a message through a social media platform.

5. The method of claim 1, wherein the behavior profiles of the participants are dynamically created for the participants whose profiles do not exist in the knowledge base or a default general behavior type is used for the participants.

6. The method of claim 1, wherein the behavior profiles are retrieved from the knowledge base through a collaborator client using a representational state transfer message.

7. The method of claim 1, wherein executable actions are transmitted to the communication devices through at least one collaborator client using a representational state transfer message.

8. The method of claim 2, wherein the monitoring of the communication includes measuring a response time by each of the participants.

9. The method of claim 2, wherein the monitoring of the communication includes measuring an amount of time taken by each of the participant during the communication, wherein a speak-to-listen rate is established for each participant during on-going communication.

10. The method of claim 2, wherein the monitoring of the communication includes analyzing written text of the communication for length, key phrases, and style.

11. The method of claim 2, wherein the monitoring of the communication includes measuring at least one of volume, tonality, pitch level, percentage of time taken by each of the participants, attributes establishing real-time behavioral events affecting communication, or general psychological measurements.

12. The method of claim 3, wherein the unique key includes an E-mail address.

13. The method of claim 3, wherein if the unique key is not found, default executable actions are generated from a default behavior profile.

14. The method of claim 3, wherein written text of the communication is analyzed to retrieve the unique key.

15. The method of claim 12, wherein an identifier of one of the participants is used to retrieve the E-mail address.

16. The method of claim 15, in which the identifier is at least one of a phone number, a screen name, a username, and a log in name.

17. A method for generating executable actions for enhancing digital communications using behavior profiles of participants, the method comprising:
using a processor system to retrieve a unique key of one of the participants from a knowledge base, wherein a phone number is used to retrieve the unique key if the unique key address is not readily determined;
identifying a participant from the unique key;
retrieving specific executable actions from the knowledge base based on a behavior type of the identified participant or based on a combination of behavior types of participants, wherein if the unique key is not found, default executable actions are built from the knowledge base based on a default behavior profile; and
transmitting the specific executable actions or the default executable actions from the knowledge base to other participants in a communication.

18. The method of claim 17, wherein the default executable actions generated from the default behavior profile are transmitted to the other participants in the communication in the form of prompts and queues.

19. The method of claim 17, wherein the unique key is an E-mail address.

20. The method of claim 17, wherein if the participant cannot be identified from the retrieved unique key, the default executable actions are built based on the default behavior profiles.

21. The method of claim 17, wherein the unique key retrieved from the knowledge base through a collaborator client using a representational state transfer message.

22. The method of claim 17, wherein the specific or the default executable actions are transmitted to the communication devices through at least one collaborator client using a representational state transfer message.

23. A system for enhancing digital communications using behavior profiles of participants, comprising:
a processor system having a knowledge base, wherein, upon initiation of a communication by one of the participants, the processor system is operable to retrieve the behavior profiles of the participants from the knowledge base;
a generating arrangement to generate executable actions for each of the participants from a determined behavior type from the stored behavior profiles of the other participants; and
a transmitting arrangement to transmit the executable actions to communication devices of the participants, each participant receiving a distinct set of executable actions.

24. The system of claim 23, wherein the processor system provides additional executable actions from the knowledge base to each of the participants based on a monitoring of the communication and conditions for activation of specific relevant types of executable actions.

25. The method of claim 17, wherein a monitoring of the communication includes measuring a response time by each of the participants.

26. The method of claim 25, wherein the monitoring of the communication includes analyzing written text of the communication for length, key phrases, and style.

27. The method of claim 25, wherein the monitoring of the communication includes measuring at least one of volume, tonality, pitch level, or general psychological measurements.

28. A computer readable medium having a program, which is executable by a processor, comprising:
a program code arrangement having program code for enhancing digital communications using behavior profiles of participants, by performing the following:
upon initiation of a communication by one of the participants, using a processor system to retrieve the behavior profiles of the participants from a knowledge base;
generating executable actions for each of the participants from a determined behavior type from the stored behavior profiles of the other participants or executable actions available in the knowledge base for a specific combination of types for the participants; and
transmitting the executable actions to communication devices of the participants, each participant receiving a distinct set of executable actions.

29. The computer readable medium of claim 28, wherein the program code arrangement provides additional executable actions from the knowledge base to each of the participants based on a monitoring of the communication.

30. A system for enhancing digital communications using behavior profiles of participants, comprising:
a collaboration engine having a behavioral profile knowledge base, the collaboration engine being an internet cloud computing arrangement, wherein the behavioral profile knowledge base includes behavioral profiles of participants if the behavior profiles exist;
a communication arrangement having a collaboration module for communicating with the collaboration engine; and
at least two communication terminal arrangements for providing a communication session between the at least two participants.

31. The system of claim 30, wherein, upon initiation of a communication by one of the participants, the collaboration engine and the collaboration module of the communication arrangement are operable to retrieve the behavior profiles of the participants from the knowledge base, wherein the collaboration engine and the collaboration module of the communication arrangement are operable to generate executable actions for each of the participants from determined stored behavior profiles of the other participants, wherein the collaboration engine and the collaboration module of the communication arrangement are operable to transmit the executable actions to communication devices of the participants, each participant receiving a distinct set of executable actions, and wherein the collaboration engine and the collaboration module of the communication arrangement are operable to provide additional executable actions from the knowledge base to each of the participants based on a monitoring of the communication.
